(19) United States
(12) Patent Application Publication
(10) Pub. No.: US 2012/0248823 A1
(43) Pub. Date: Oct. 4, 2012

(54) BULKHEAD STRUCTURE

(75) Inventors: Udo MILDNER, Limburg (DE); Karsten BOHLE, Bad Schwalbach (DE); Boris KUENKLER, Limburg (DE)

(73) Assignee: GM GLOBAL TECHNOLOGY OPERATIONS LLC, Detroit, MI (US)

(21) Appl. No.: 13/430,357

(22) Filed: Mar. 26, 2012

(30) Foreign Application Priority Data
Mar. 30, 2011 (DE) 10 2011 015 542.2

(51) Int. Cl. B62D 25/08

(52) U.S. Cl. 296/203.02

(57) ABSTRACT

A bulkhead structure is provided for a motor vehicle. Connecting areas that lie in the longitudinal direction of the bulkhead structure are provided for connecting the bulkhead structure to at least two strut mounts of the motor vehicle. The bulkhead structure is stepped at least twice transverse to its longitudinal direction with steps.

### CROSS-REFERENCE TO RELATED APPLICATION

This application claims priority to German Patent Application No. 10 2011 015 542.2, filed Mar. 30, 2011, which is incorporated herein by reference in its entirety.

### TECHNICAL FIELD

The technical field relates to a bulkhead structure for a motor vehicle, and further relates to a front end of a motor vehicle, as well as to the motor vehicle itself.

### BACKGROUND

The increasingly strict legislation with respect to the CO₂-emissions of motor vehicles makes it necessary to rethink new developments and further developments of vehicles. One pertinent measure reduces the overall weight of the vehicles. Despite this weight optimization, the more stringent requirements with respect to the service life, the driving comfort and the protection of passengers and pedestrians need to be taken into consideration in new developments and further developments of motor vehicles.

Bulkhead structures of the relevant type usually serve for sealing off the engine compartment of a motor vehicle from liquid that runs off the front windshield. Bulkhead structures of this type may alternatively or additionally serve for sealing off the fresh air intake of a heating and/or air-conditioning system of the motor vehicle from the engine compartment and possibly emitted exhaust gases. In the recent past, bulkhead structures were constructively optimized such that the bulkhead structures simultaneously fulfill the function of the strut brace of a motor vehicle. For this purpose, the bulkhead structures feature connecting areas that lie in their longitudinal direction and make it possible to connect the bulkhead structures to the at least two front end strut mounts of a motor vehicle. Consequently, the relatively heavy strut braces that were typically used so far are no longer required and can be eliminated such this measure already results in a weight reduction.

However, bulkhead structures of this type usually have a greater wall thickness at least in the region of the sections that act as a strut brace in order to optimally fulfill the function of the strut brace, namely the function of increasing the torsional rigidity of the car body in the region of the front end.

In view of the foregoing, at least one aim is to make available a bulkhead structure for a motor vehicle with the initially cited characteristics that features sufficient bracing for also functioning as a strut brace and simultaneously has the least weight possible. At least another aim is to make available a front of a motor vehicle, as well as a motor vehicle, suitable for use with such a bulkhead structure. In addition, other aims, desirable features, and characteristics will become apparent from the subsequent summary and detailed description, and the appended claims, taken in conjunction with the accompanying drawings and this background.

### SUMMARY

A bulkhead structure is provided for a motor vehicle preferably serves for sealing off the engine compartment of a motor vehicle from liquid that runs off its front windshield and/or for sealing off the fresh air intake of a heating and/or air-conditioning system of the motor vehicle from its engine compartment and possibly emitted exhaust gases. The bulkhead structure has connecting areas that lie in its longitudinal direction and serve for connecting the bulkhead structure to at least two preferably frontal or front end strut mounts of the motor vehicle. To this end, the connecting areas may feature at least one wall section that serves as a flange for fixing the bulkhead structure on the respective strut mounts. The strut mounts preferably has left and the right strut mounts of the motor vehicle body.

The connecting areas may be designed for connection with welding, riveting and/or clinching. It would also be conceivable to design the connecting areas for spot welding. The connecting areas may also be designed for punch riveting.

The bulkhead structure is stepped at least twice transverse to its longitudinal direction with steps. Due to this measure, the bulkhead structure has a significant reinforcing effect. The structural reinforcement is achieved with the steps extending in the longitudinal direction of the bulkhead structure. In this way, the bulkhead structure can be realized with a smaller wall thickness without negatively affecting the reinforcing effect and therefore its ability to function as a strut brace. Consequently, relatively thin-walled parts, particularly sheet metal, can be used for the bulkhead structure such that a reduction of the vehicle weight and the production costs is achieved.

The gradations or steps of the bulkhead structure formed by two sections of the bulkhead structure that are arranged angular to one another, form a step and preferably extend in the longitudinal direction of the bulkhead structure. The respective step that forms the initial step or the final step may also be formed by only one section such that no section that lies angular thereto is provided in this case. The steps preferably form a stepped profile in the transverse direction of the bulkhead structure. In this case, the steps are arranged adjacent to one another in the transverse direction of the bulkhead structure.

In the installed state of the bulkhead structure, the edges of the steps extending in the longitudinal direction of the bulkhead structure preferably should be aligned essentially transverse to the driving direction of the vehicle. In this way, a torsional rigidity of the car body is achieved in a particularly effective fashion, especially in the region of the front end of the motor vehicle. It is practical that at least one of the steps continuously extends in the longitudinal direction of the bulkhead structure. An additionally improved bracing of the bulkhead structure is achieved with such a continuous step in the longitudinal direction of the bulkhead structure. The measure, according to which at least one other step extends consistently or continuously in the longitudinal direction of the bulkhead structure, also serves for achieving the same effect.

It is furthermore practical to produce the steps with metal forming such as, for example, bending, punching and/or embossing. In this way, the steps can be realized in a particularly simple fashion with respect to the manufacturing technology. It would furthermore be conceivable that the entire bulkhead structure has a formed metal part.

According to an embodiment, it is proposed that the bulkhead structure can be fixed on the strut mounts by means of a wall section of the connecting areas that essentially lies horizontally in the installed state. This prevents any section of the bulkhead structure from extending up to or into the region of the hood structure. This also ensures a sufficient deformation clearance for the deformation of the hood structure in case of a crash and therefore provides maximum protection for pedestrians who strike the hood. The bulkhead structure is preferably fixed on the strut mounts with a wall section of the connecting areas that forms part of the upper section of the top step or is attached to the upper section of the first step.

According to another embodiment, a reinforcing structure is provided and connected to the bulkhead structure such that a closed hollow profile is formed. In this way, the bulkhead structure is additionally reinforced and has a particularly high rigidity. The hollow profile may be formed by a rectangular cross section. A profile that can be manufactured in a geometrically simple fashion is realized due to this rectangular cross section.

It is practical to arrange the reinforcing structure between the strut mounts. Due to this measure, the reinforcing structure has a strengthening or reinforcing effect on the bulkhead structure at the locations, at which the bulkhead structure functions as a strut brace and should improve the lateral rigidity of the car body spring mounts, as well as the rigidity of the entire interconnected car body, particularly the front end.

According to another embodiment, the reinforcing structure features flanges or flange sections, by which the reinforcing structure can be connected to the strut mounts. Since the reinforcing structure is fixed on the strut mounts, forces can be directly transmitted from the strut mounts into the spring reinforcing structure. The bulkhead structure and the reinforcing structure have a particularly strengthening or reinforcing effect on the vehicle body due to the fact that the reinforcing structure and the bulkhead structure are respectively fixed on the strut mounts. The flange sections or the flanges may be designed for being connected by means of welding, riveting and/or clinching. It would also be conceivable to design the flange sections or the flanges for being connected by means of spot welding and/or for being connected by means of punch riveting.

According to another embodiment, the reinforcing structure features at least two mutually angled sections that are connected to the mutually angled sections of one of the steps or the mutually angled sections of at least two of the steps such that the hollow profile is formed. In this case, a particularly effective reinforcement of the bulkhead structure is achieved with the reinforcing structure due to the fact that the reinforcing structure engages on two different sections of one step or different steps of the bulkhead structure and the fact that the connection between the reinforcing structure and the bulkhead structure extends in the longitudinal direction of the bulkhead structure.

The reinforcing structure may feature at least one or several connecting points, particularly brackets, on which components of the motor vehicle or the car body can be fixed. For example, an ABS control unit, a reservoir, clips for fixing cable harnesses or the like can be installed at the connecting points. This eliminates the need for separate holding elements. It is practical to realize the reinforcing structure in the form of an L-shaped profile.

This makes it possible to realize the reinforcing structure in a technically simple fashion. The reinforcing structure may be realized in the form of a crossmember. It would also be conceivable to realize the reinforcing structure in the form of a crossmember with an L-shaped profile.

According to an embodiment, it is proposed that at least one of the steps at least partially ends in front of or at the connecting areas, particularly the connecting points, referred to the longitudinal direction of the bulkhead structure. This results in a bulkhead structure that can be manufactured in a geometrically simple fashion and is essentially free of edges, particularly sharply bent edges, of the at least one step in the region of the connecting areas. Consequently, the inventive bulkhead structure can be realized in a relatively simple fashion with respect to the manufacturing technology. The bulkhead structure not only fulfills its function of sealing off the engine compartment from liquid running off the front windshield, but also the function of a strut brace in order to improve the lateral rigidity of the strut mounts and the torsional rigidity of the car body, particularly the front end thereof.

According to another embodiment, at least one edge of the at least one step that extends in the longitudinal direction of the bulkhead structure transforms or leads into an edge of another step that extends in the longitudinal direction of the bulkhead structure, particularly a section of one of the other steps that is connected to the reinforcing structure. This measure is also intended to reinforce a bulkhead structure with the lowest possible weight in such a way that it can fulfill its function as a strut brace in a particularly effective fashion and thusly improve the torsional rigidity of the front end, particularly of the entire vehicle body.

According to another embodiment, it is proposed that the bulkhead structure forms part of the water collector of the motor vehicle, by which the liquid running off the front windshield of the motor vehicle is diverted laterally of the motor vehicle. The water collector of the motor vehicle may be at least partially formed by the bulkhead structure and the vehicle firewall. In this way, components that already exist on the motor vehicle are used for realizing the water collector such that no separate components are needed for the water collector. An additional weight reduction is achieved due to this measure.

It is practical to arrange the reinforcing structure outside the water collector of the motor vehicle. The reinforcing structure should preferably be arranged underneath the water collector of the motor vehicle. Due to these measures, the reinforcing structure is arranged outside the wet area of the water collector and therefore protected from the liquid accumulating in the water collector. The risk of corrosion on the reinforcing structure therefore is reduced.

According to another embodiment, a water collector is provided for a motor vehicle with a bulkhead structure of the above-described type. A front end of a motor vehicle is also provided in accordance with an embodiment that is equipped with a bulkhead structure of the above-described type, and an embodiment also pertains to a motor vehicle with a bulkhead structure of the above-described type.

### BRIEF DESCRIPTION OF THE DRAWINGS

The present invention will hereinafter be described in conjunction with the following drawing figures, wherein like numerals denote like elements, and:

FIG. 1 shows a perspective representation of an potential embodiment of a bulkhead structure that is installed in the front end of a motor vehicle;

FIG. 2 shows a perspective front view of the bulkhead structure according to FIG. 1;

FIG. 3 shows a perspective rear view of the bulkhead structure according to FIG. 1;

FIG. 4 shows a section through the front end according to FIG. 1 with the inventive bulkhead structure along the line of section A-A in FIG. 2;

FIG. 5 shows a reinforcing structure for reinforcing the bulkhead structure according to FIG. 1; and

FIG. 6 shows a section through the front end according to FIG. 1 along the line of section B-B in FIG. 1.

### DETAILED DESCRIPTION

The following detailed description is merely exemplary in nature and is not intended to limit application and uses. Furthermore, there is no intention to be bound by any theory presented in the preceding background or summary or the following detailed description.

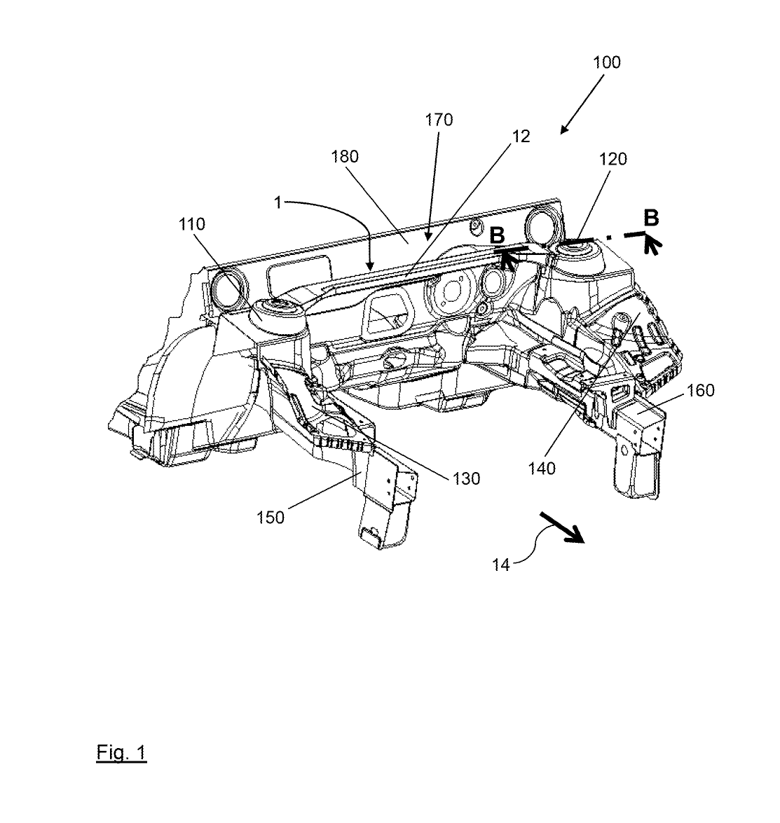

FIG. 1 shows a front end 100 of a motor vehicle with two car body strut mounts 110 and 120 that preferably form the strut mount on the right side and the strut mount on the left side of the front end 100. FIG. 1 furthermore shows the front wheel housings 130 and 140 for the front wheels of the motor vehicle, which are not illustrated in FIG. 1. It is preferred that each of the wheel housings 130 or 140 is respectively connected to the strut mount 110 or 120 that lies on the same side or that the strut mounts 110 and 120 respectively form part of the wheel housings 130 and 140. On their inner wall, the wheel housings 130 and 140 are respectively connected to longitudinal beams 150 and 160 that protrude beyond the wheel housings 130 and 140 in the driving direction 14.

The front end 100 features a vehicle firewall 180 that forms a water collector 170 together with a bulkhead structure 1. The bulkhead structure 1 serves for draining away the liquid running off the front windshield of the motor vehicle, which is not illustrated in FIG. 1. The liquid is diverted laterally outward by the water collector 170. The liquid may also take place through lateral openings in the wheel housing 130 or 140 or in the lateral firewall of the vehicle body, which are not illustrated in FIG. 1). According to FIG. 1, the bulkhead structure 1 is simultaneously designed for being connected to the strut mounts 110, 120 and consequently for functioning as a strut brace between the strut mounts 110 and 120.

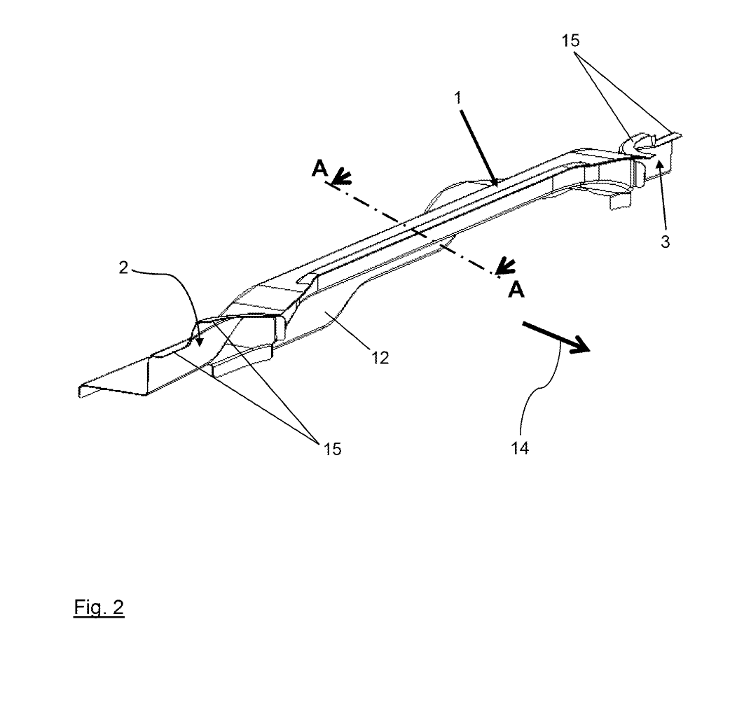

FIG. 2 shows an illustration of the bulkhead structure 1 only. The bulkhead structure 1 is illustrated in the form of a perspective representation opposite to the driving direction 14. The bulkhead structure 1 features connecting areas 2, 3 that lie in its longitudinal direction and serve for connecting the bulkhead structure 1 to the strut mounts 110, 120. The bulkhead structure 1 preferably can be fixed on the strut mounts 110, 120 by means of at least one or several wall sections 15 of the connecting areas 2, 3. It is preferred that the wall sections 15 essentially lie horizontally in the installed state.

The wall sections 15 may form part of the upper horizontal surface of the bulkhead structure 1 such that the bulkhead structure 1 has a flat design toward the hood in the installed state and sufficient deformation clearance for the hood structure of the motor vehicle is provided. The wall sections 15 are preferably realized in the form of welded flanges. The connecting areas 2, 3 are preferably arranged on the ends of the bulkhead structure 1 and form the end regions of the bulkhead structure 1 referred to its longitudinal direction. The bulkhead structure 1 preferably features an additional reinforcing structure 12 that is fixed on the bulkhead structure 1 and preferably lies essentially between the strut mounts 110 and 120. The reinforcing structure 12 is structurally connected to the bulkhead structure 1, for example, rigidly connected to the bulkhead structure 1 by means of welding, soldering, bonding, screws or the like. The bulkhead structure 1 is preferably formed of sheet metal. It is practical that the reinforcing structure 12 is also formed of sheet metal.

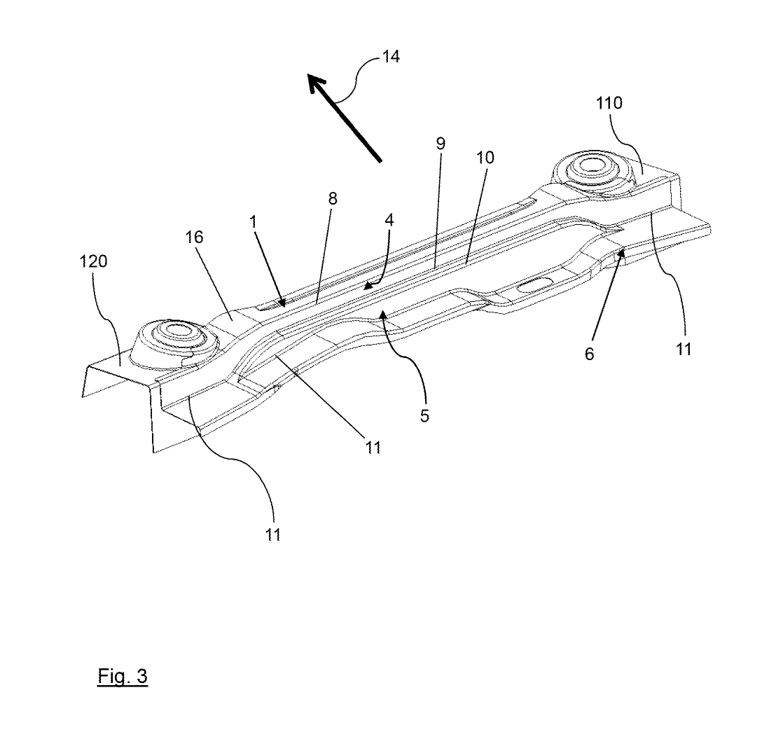

FIG. 3 shows the bulkhead structure 1 in the installed state on the strut mounts 110 and 120 in the form of a perspective representation in the driving direction 14. According to FIG. 3, the bulkhead structure 1 is stepped threefold transverse to its longitudinal direction and accordingly features steps 4, 5 and 6 that extend in the longitudinal direction of the bulkhead structure. The steps 4, 5 and 6 preferably form a stepped profile referred to the transverse direction of the bulkhead structure 1.

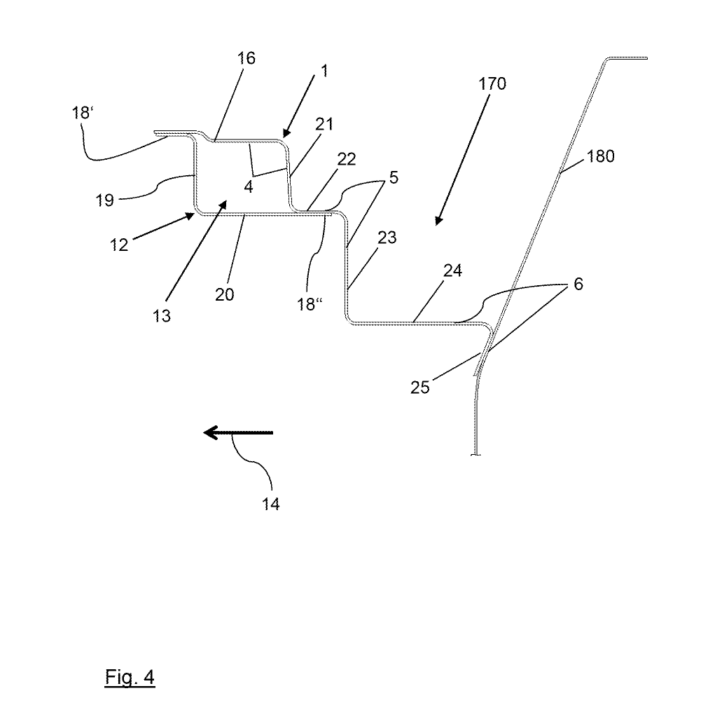

FIG. 4 shows a section through the bulkhead structure 1 with its steps 4, 5 and 6 along the line of section A-A in FIG. 2. According to FIG. 3 and FIG. 4, the step 4 forms the upper or top step in the installed state of the bulkhead structure 1 and features an upper section 16 that preferably lies horizontally in the installed state. Another section 21 extending in the longitudinal direction of the bulkhead structure 1 lies adjacent to the section 16 referred to the transverse direction of the bulkhead structure 1. The sections 16 and 21 are arranged angular to one another, preferably orthogonal to one another, such that the section 21 essentially extends vertically in the installed state of the bulkhead structure 1. The section 21 lies adjacent to the step 5 formed by two sections 22 and 23 that are also arranged angular to one another. The section 22 is preferably arranged horizontally in the installed state of the bulkhead structure 1 while the section 23 extends essentially orthogonal thereto and essentially lies vertically in the installed state of the bulkhead structure 1.

The step 6 formed by the mutually angled sections 24 and 25 lies adjacent to the section 23 referred to the transverse direction of the bulkhead structure 1. The step 6 is preferably realized such that the section 24 essentially lies horizontally in the installed state of the bulkhead structure 1 while the section 25 preferably extends at an acute angle to the section 24. The section 25 is preferably realized in the form of a flange section that serves for being connected to the vehicle firewall 180, wherein the water collector 170 is formed by connecting the bulkhead structure 1 to the vehicle firewall 180.

FIG. 3 shows how the steps 4, 5 and 6 extend in the longitudinal direction of the bulkhead structure 1. It is proposed that one of the steps 4, 5, 6, namely the step 5, already ends in front of or essentially at the connecting areas 2 and 3. In the region of its longitudinal end, the bulkhead structure 1 is preferably realized such that the edges 10 and 11 of the step 5 extending in the longitudinal direction of the bulkhead structure 1 essentially transform into the section 24 of the step 6. The edge 9 of the step 5 preferably leads into the edge 11 of the step 6 extending in the longitudinal direction of the bulkhead structure 1.

FIG. 4 shows a section through the reinforcing structure 12 according to FIG. 2. The reinforcing structure 12 is preferably formed by an L-profile with mutually angled sections 19 and 20 that form the limbs of the L-shape. A flange section 18′ is attached to the end of the longitudinal side of the section 19. This flange section protrudes outward from the section 19 at a certain angle, preferably a right angle, and serves as a flange section for being connected to the bulkhead structure 1. The reinforcing structure 12 is structurally connected such as, for example, welded to the upper section 16 of the step 4 by means of the flange section 18′. In addition, a flange section 18″ is provided on the section 20 of the reinforcing structure 12, by means of which the reinforcing structure 12 is structurally connected such as, for example, welded to the section 22 of the step 5. A hollow profile that extends in the longitudinal direction of the bulkhead structure 1 is formed in the transverse direction of the bulkhead structure 1 due to the design of the reinforcing structure 12 in connection with the bulkhead structure 1.

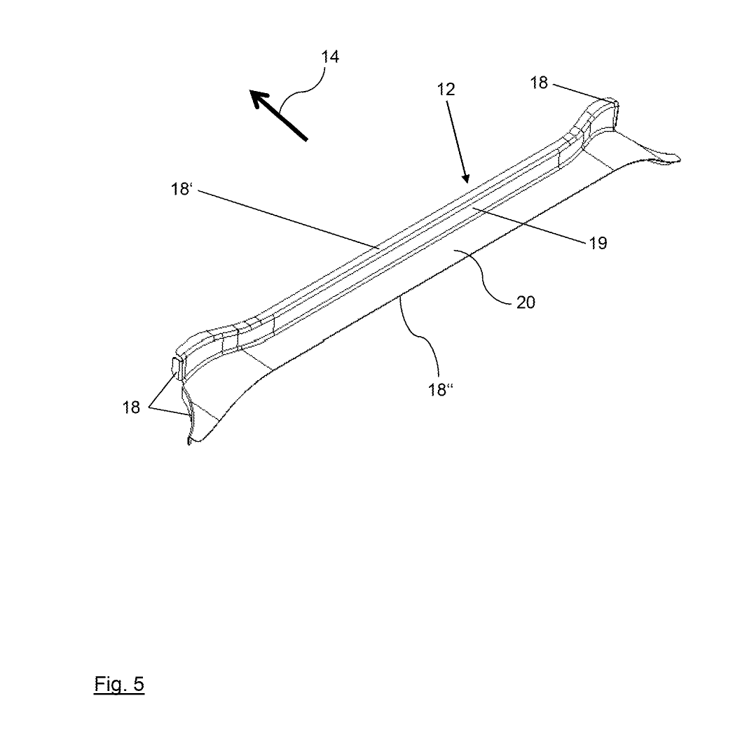

FIG. 5 shows the reinforcing structure 12 only. On its two longitudinal ends, the bulkhead structure 12 respectively features flange sections 18 that serve for fixing, particularly welding, and the bulkhead structure 1 on the lateral strut mounts 110, 120 of the front end 100.

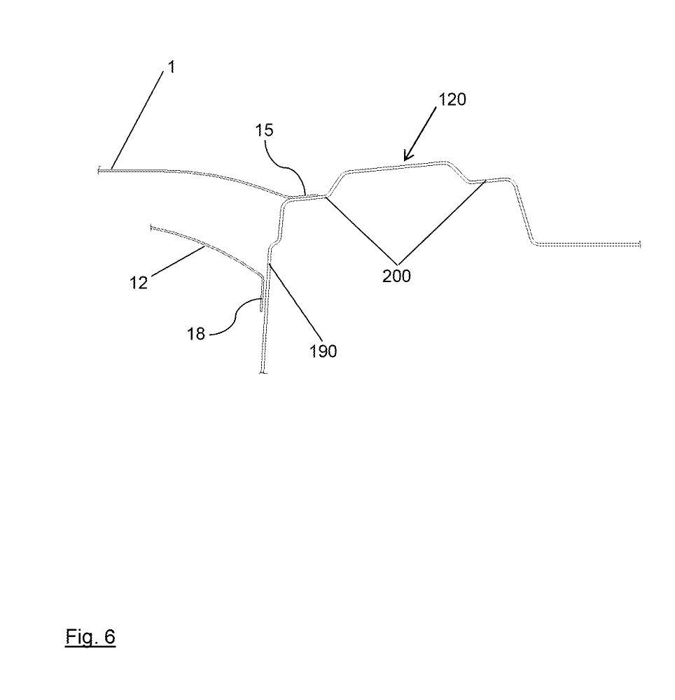

FIG. 6 shows a section through the front end 100 along the line of section B-B in FIG. 1. This figure also shows the strut mount 120 with its essentially vertical wall 190 and the circumferential, essentially horizontal upper wall surface 200. The bulkhead structure 1 preferably is fixed, particularly welded, on the horizontal wall surface 200 of the strut mounts 120 with its wall sections 15. The reinforcing structure 12 is fixed, particularly welded, on the vertical wall 190 of the strut mount 120 with its flange sections 18. The connection of the bulkhead structure 1 and the reinforcing structure 12 on the strut mount 110 preferably is also realized as described with reference to the strut mount 120 according to FIG. 6.

A bulkhead structure is realized that simultaneously fulfills the function of a strut brace in the form of a crossmember for connecting the strut mounts of a motor vehicle. A high rigidity of the bulkhead structure is achieved due to the stepped cross-sectional profile thereof such that even small wall thicknesses of the bulkhead structure suffice for adequately fulfilling the function of a strut brace. This not only results in a reduction of the production costs due to the utilization of thin sheet metal, but also in a weight reduction. The bulkhead structure simultaneously seals off the engine compartment from moisture. The material used and therefore the weight can be further reduced due to the fact that the bulkhead structure can be simultaneously used for forming the water collector of the motor vehicle.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A bulkhead structure of a motor vehicle, comprising:
connecting areas that lie in a longitudinal direction and configured to connect the bulkhead structure to at least two strut mounts of the motor vehicle; and
a plurality of steps that are configured to step at least twice transverse to the longitudinal direction of the bulkhead structure.

2. The bulkhead structure according to claim 1, wherein edges of the plurality of steps extending in the longitudinal direction of the bulkhead structure are aligned essentially transverse to a driving direction of the motor vehicle in an installed state of the bulkhead structure.

3. The bulkhead structure according to claim 1, wherein a first step of the plurality of steps that continuously extends in the longitudinal direction of the bulkhead structure.

4. The bulkhead structure according to claim 1, wherein a second step of the plurality of steps that continuously extends in the longitudinal direction of the bulkhead structure.

5. The bulkhead structure according to claim 1, wherein the plurality of steps are metal formed steps.

6. The bulkhead structure according to claim 1, wherein the bulkhead structure is configured for fixing on strut mounts with a wall section of the connecting areas that essentially lies horizontally in an installed state of the bulkhead structure and forms part of an upper section of a top step.

7. The bulkhead structure according to claim 1, further comprising a reinforcing structure connected to the bulkhead structure that forms a closed hollow profile.

8. The bulkhead structure according to claim 7, wherein the reinforcing structure is arranged between strut mounts.

9. The bulkhead structure according to claim 8, wherein the reinforcing structure comprises a plurality of flanges by which the reinforcing structure connects to the strut mounts.

10. The bulkhead structure according to claim 7, wherein the reinforcing structure comprises at least two mutually angled sections that are connected to mutually angled sections of a first step of the plurality of steps.

11. The bulkhead structure according to claim 1, wherein at least one step of the plurality of steps is configured to at least partially ends in front of the connecting areas.

12. The bulkhead structure according to claim 10, wherein the bulkhead structure is configured to form a part of a water collector of the motor vehicle.

13. The bulkhead structure according to claim 12, wherein the reinforcing structure is arranged outside the water collector of the motor vehicle.
